(19) United States
(12) Patent Application Publication
(10) Pub. No.: US 2005/0130505 A1
(43) Pub. Date: Jun. 16, 2005

(54) Assembled structure of a connector

(75) Inventor: Ching-Wen Weng, Tu-Cheng City (TW)

Correspondence Address: TROXELL LAW OFFICE PLLC, 5205 LEESBURG PIKE, SUITE 1404, FALLS CHURCH, VA, 22041, US

(73) Assignee: Plastron Precision Co., Ltd.

(21) Appl. No.: 10/731,469

(22) Filed: Dec. 10, 2003

(51) Int. Cl. H01R 24/00

(52) U.S. Cl. 439/676

(57) ABSTRACT

The present invention relates to an assembled structure of a connector, which comprises a printed circuit board (PCB), an I/O port, a connector socket configured on a jack frame, wherein spring jackwires in the I/O port and beam contacts in the connector socket form spring plates, so that the spring plates can get a close contact with corresponding terminals and the jackwire block and the connector block can be fixed on the PCB when the jackwire block in the I/O port and the slot in the connector socket joins corresponding terminals on the PCB respectively.

### FIELD OF THE INVENTION

The present invention relates to an assembled structure of a connector, particularly to a structure in which the I/O port and connector socket can be connected with the printed circuit board (PCB) fast.

### BACKGROUND OF THE INVENTION

In traditional connectors, spring jackwires in the I/O port and beam contacts in the connector socket are welded with the PCB to form I/O terminals for signals. Usually, in PCB of such a connector, terminals must cross the PCB to form a through conductive pole in the holes, thus spring jackwires in the I/O port and beam contacts in the connector socket are connected to the PCB in a way of welding or pressing, and such a structure can match wires upon and under the surface of the PCB.

### SUMMARY OF THE INVENTION

However, in such an assembled structure of said traditional connector, spring jackwires in the I/O port and beam contacts in the connector socket are connected to terminals on the PCB in a way of welding or pressing, the method is difficult and cost lots of time. Furthermore, in the PCB of such a connector, terminals crossing the PCB will form a through hole structure; which will cause capacitance efficiency and crosstalk among wires. Therefore, an object of the present invention is to solve disadvantages of structure of traditional connector.

The present invention relates to an assembled structure of connector, so as to one or more limitations or disadvantages in said related art.

An assembled structure of a connector according to the present invention comprises a PCB, an I/O port and a connector socket configured in a jack frame, wherein spring jackwires in the I/O port and beam contacts in the connector socket form spring plates, so that the spring plates can get a close contact with corresponding terminals and the jackwire block and the connector block can be fixed on the PCB when the jackwire block in the I/O port and the slot in the connector socket joins corresponding terminals on the PCB respectively.

An assembled structure of a connector according to the present invention has the following advantages:

1. In assembled structure of a connector according to the present invention, the spring plates formed by spring jackwires in the I/O port and beam contacts in the connector socket enable the jackwire block in the I/O port and the slot in the connector socket to join said PCB to fix on said PCB.

2. In assembled structure of a connector according to the present invention, the spring plates formed by spring jackwires in the I/O port and beam contacts in the connector socket enable to stably contact, so welding is avoided and the assembling can be implemented by PCB being inserted in said I/O port or said connector socket.

3. With the assembled structure of a connector according to the present invention, the spring plate structure formed by spring jackwires in the I/O port and beam contacts in the connector socket enables to said spring plates to change their size or position to match the layout of wires on said PCB; thus crosstalk can be reduced according to the match with layout of wires.

4. With the assembled structure of a connector according to the present invention, the spring plate structure formed by spring jackwires in the I/O port and beam contacts in the connector socket can match the layout of wires on the PCB, so the through conductive hole structure through PCB is unnecessary, therefore capacitance efficiency and crosstalk can be avoided.

### BRIEF DESCRIPTION OF THE DRAWINGS

FIG. 1 is a 3D combined diagram of an assembled structure of a connector according to the present invention.

FIG. 2 is a 3D exploded diagram of an assembled structure of a connector according to the present invention.

FIG. 3 is a sectional view of the combination of the I/O port and PCB in an assembled structure of a connector according to the present invention.

FIG. 4 is a sectional view of the combination of the connector socket and PCB in an assembled structure of a connector according to the present invention.

printed circuit board (1)

wire (11)

connector terminals (13)

I/O port (2)

spring jackwire (21)

spring plate (21a)

jackwire block (22)

connector socket (3)

beam contact (31)

spring plate (31a)

slot (32)

jackframe (4)

### DETAILED DESCRIPTION OF THE EMBODIMENTS

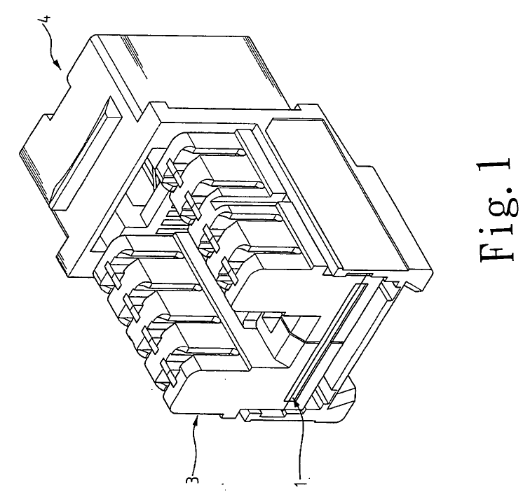

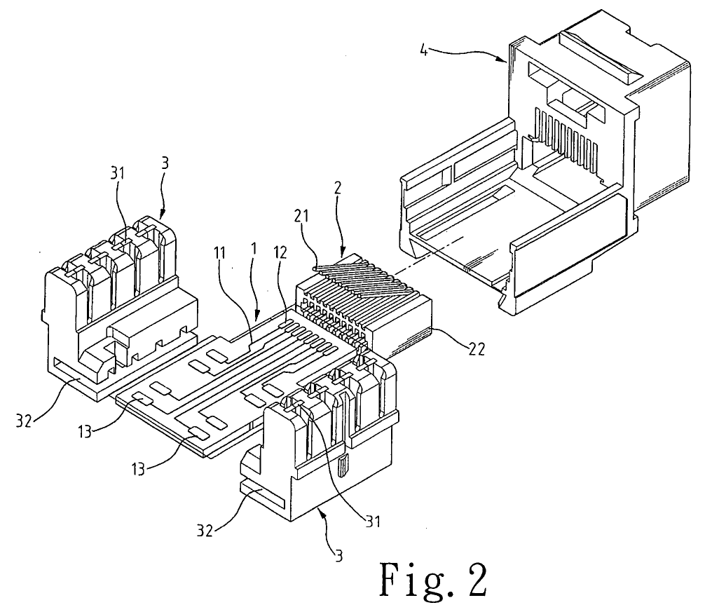

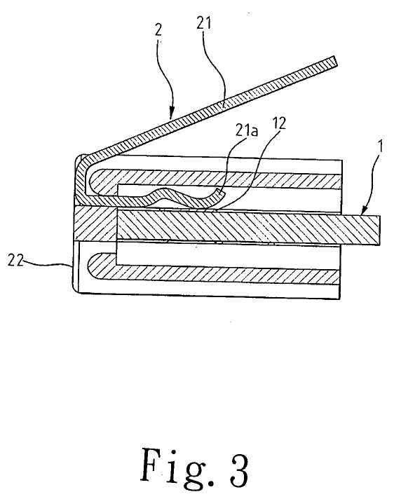

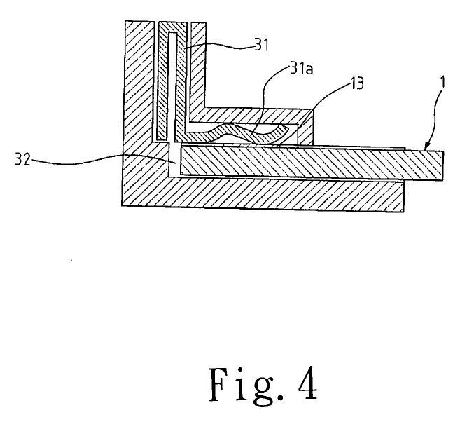

A preferred embodiment of the present invention will be described in detail with reference to FIG. 1, FIG. 2, FIG. 3 or FIG. 4, an assembled structure of a connector according to the present invention comprises:

A PCB (1), which has a plurality of wires (11) (act as signal channel), wires (11) form a plurality of jackwire terminals (12) and connector terminals (13) at the front or back of the said PCB in a one-one manner. Moreover, said jackwire terminals (12) and said connector terminals (13) are both formed by metal layer.

Referring to FIG.3, an I/O port (2) has a plurality of spring jackwires (21) and said spring jackwires (21) correspond to said each jackwire terminal (12) in a one-one manner, each spring jackwire is fixed at the front of a jackwire block (22) respectively so that each spring jackwire (21) is electrically insulated with each other, said jackwire block (22) is hollow and can be embedded in said PCB (1), and each spring jackwire (21) extends downwards to inside of said jackwire block (22) to form a spring plate (21a) with deflection.

Referring to FIG. 4 and FIG. 5, a plurality of beam contacts (31) are arranged on a connector socket (3) and corresponds to said connector terminals (13) in a one-one manner, and each connector terminal (13) is respectively fixed in said connector socket (3), so each connector terminal (13) can be electrically insulated with each other, a slot (32) is formed at the bottom of said connector socket (3), said slot (32) can be embedded in said PCB (1), so that bottom of each beam contact (31) can extends downwards to inside of said slot (32) to form a spring plate (31a) with deflection. Moreover, said connector socket (3) particularly refers to two connector sockets (3) in left and right symmetry.

A jack frame (4), which can match the structure composed of said PCB (1), said I/O port (2) and said connector socket (3).

Said jackwire terminals (12) and connector terminals (13) on said PCB (1) are distributed anywhere on the PCB (1) or the upper-surface or the undersurface of said PCB (1), in order to match said layout of wires, and said I/O port (2) and said connector socket (3) only need to change the length or extending angel of the spring plate 21a—the bottom of said corresponding spring jackwire 21 or the spring plate 31a—bottom of said beam contact (31), as long as each spring plate can touch each terminal.

With the assembled structure of a connector according to the present invention, when the PCB (1) is embedded in the jackwire block (22) of said I/O port (2), jackwire terminals (12) on said PCB (1) will correspond to and contact the bottom spring plates (21a) of spring jackwires (21) of said I/O port (2) in a one-one manner, and enable to stably contact with corresponding jackwire terminals (12) and enable said jackwire block (22) to be fixed at the front of said PCB (1) through the elasticity provided by said spring plates (21a).

Also, when said PCB (1) is embedded in the slot (32) of said connector socket (3), connector terminals (13) of said PCB (1) will correspond to and contact with beam contacts (31) of the bottom spring plates (31a) of beam contacts (31) of said connector socket (3) in a one-one manner, and enable to stably contact with corresponding connector terminals (13) and enable said slot (32) to be fixed at the back of said PCB (1) through the elasticity provided by said spring plates (31a).

Also, if an assembled structure of a connector with two in symmetry, then said two connector socket (3) are arranged in left and right symmetry and are embedded in corresponding connector terminals (13) in said PCB (1) through the slot (32) respectively, which enables to connector terminals (13) correspond to and contact with beam contacts (31) of the bottom spring plates (31a) of beam contacts (31) of said connector socket (3) in a one-one manner, and enable to stably contact with corresponding connector terminals (13) and enable said slot (32) to be fixed at both sides of said PCB (1) through the elasticity provided by said spring plates (31a).

Although the present invention is described with reference to a preferred embodiment, any skilled in this field can modify it without escaping the spirit and scope of the present invention, therefore the protecting scope should be defined by the following claims.

1. An assembled structure of a connector, comprising a printed circuit board (PCB), an I/O port and a connector socket configured in a jack frame, wherein:
wires (11) on said PCB form a plurality of jackwire terminals and connector terminals at the front or back of the said PCB in a one-one manner, said jackwire terminals (12) and said connector terminals (13) are both formed by metal layer;
said I/O port has a plurality of spring jackwires corresponding to said jackwire terminals, each spring jackwire is fixed at the front of a jackwire block respectively so that each spring jackwire is electrically insulated with each other, said jackwire block is hollow and embedded in said PCB, and each spring jackwire extends downwards to inside of said jackwire block to form a spring plate with deflection;
a plurality of beam contacts corresponding to said connector terminals are arranged on a connector socket in a one-one manner, and each connector terminal is respectively fixed in said connector socket, so each connector terminal is electrically insulated with each other, a slot is formed at the bottom of said connector socket, said slot can be embedded in said PCB, so that bottom of each beam contact extends downwards to inside of said slot to form a spring plate with deflection;
the jackwire block of said I/O port and slot of-said connector socket join said PCB respectively, which enables each jackwire terminal to contact corresponding spring plates in said I/O port, and enables each connector terminal to contact each corresponding bottom spring plates of each beam contact; and enables each spring plate to stably contact corresponding terminal and enables said jackwire block and said connector to be fixed on said PCB.

2. An assembled structure of a connector according to claim 1, wherein said connector socket particularly refers to two connector sockets in left and right symmetry.
